(19) United States
(12) Patent Application Publication
(10) Pub. No.: US 2022/0278425 A1
(43) Pub. Date: Sep. 1, 2022

(54) Ultrasonic separation mechanism for storage batteries

(71) Applicant: Lahui TANG, Foshan (CN)

(72) Inventor: Lahui TANG, Foshan (CN)

(21) Appl. No.: 17/535,711

(22) Filed: Nov. 26, 2021

(30) Foreign Application Priority Data
Mar. 1, 2021 (CN) 202110223088.3

(51) Int. Cl. H01M 50/489; H01M 50/24; H01M 50/46

(52) U.S. Cl. CPC H01M 50/489; H01M 50/24; H01M 50/46

(57) ABSTRACT

An ultrasonic separation mechanism for storage batteries, having a separation workpiece and at least one ultrasonic vibrating element; the separation workpiece is provided with at least one interior chamber for the sealed installation of the at least one ultrasonic vibration element. The at least one ultrasonic vibrating element is installed in the at least one interior chamber, and a power supply wire extends through the at least one interior chamber and out of the separation workpiece. When the ultrasonic separation mechanism is applied between the positive and negative electrodes, the at least one ultrasonic vibrating element produces high frequency ultrasonic vibration which directly acts on the separation workpiece, creating an ultrasonic cavitation effect.

### BACKGROUND OF THE INVENTION

The present invention relates to storage batteries and more particularly pertains to a separator or separation mechanism applied to the positive electrode plate and negative electrode plate of a storage battery.

Lead acid battery comprises a positive electrode plate, a negative electrode plate, a separator, a case and electrolyte, etc. The separator is inserted between the positive electrode plate and the negative electrode plate to avoid contact of the plates and prevent short circuit. The separator is provided with a large number of small holes. This is to ensure the electrolyte to pass through, but at the same time avoid contact of the plates, so as to control the reaction speed of the electrolyte, and hence protect the battery. When a lead acid battery in the present art has been used for a period of time, lead sulfate crystals will attach to the surface of the separator. The increasing amount of the crystals will block the electrolyte from passing through. This affects the storage performance and charge-and-discharge performance of the lead acid battery, and eventually the lead acid storage battery will be unable to store power and to charge and discharge.

Lithium ion battery is mainly composed of a positive electrode (LiMn2O4 materials), a negative electrode (graphite materials), electrolyte and a separator. When a power supply is charging the battery, electrons on the positive electrode move to the negative electrode through an external circuit; lithium ions enter the electrolyte, move through the curvy holes on the separator and swim to the negative electrode, combining with the electrons arrived earlier at the negative electrode. When the battery is discharging, electrons on the negative electrode move to the positive electrode through the external circuit; lithium ions enter the electrolyte, move through the curvy holes on the separator and swim to the positive electrode, combining with the electrons arrived earlier at the positive electrode. Lithium ions depart from the positive electrode and arrive at the negative electrode after passing through the electrolyte. After the battery charges and discharges for the first time, a passivation layer of solid electrolyte, namely solid electrolyte interface (SEI), will be formed between the electrodes and the liquid electrolyte. SEI has a dual role of being an insulator of electrons and a good conductor of lithium ions. This layer protects the battery by preventing harmful reactions from occurring and allows lithium ions to travel between electrodes and the electrolyte. SEI is the key element for the performance of lithium battery. If the performance of SEI is unsatisfactory, many problems will be found. When SEI is decaying, loads of problems will arise, such as deposition inhomogeneity on the lithium electrodes, resulting in crystal formation, after multiple times of charging and discharging. These lithium metal crystals will constitute an obstacle to the movement of lithium ions, leading to a loss of battery capacity, lower charge-discharge efficiency, or, due to continuous crystal formation, the crystals may pierce through the separator, causing short circuit of the electrodes and eventually spark a fire. The working temperature for lithium battery is 0-40° C. When the ambient temperature is lower than 0° C., the pores (so-called “tiny holes”) on the separator will shrink due to thermal contraction, making it more difficult or even impossible for lithium ions to pass through the separator. Lithium ions will also be easily frozen in the electrolyte and their movement becomes slower, which makes the lithium battery unable to charge and discharge as usual, undermining the overall performance of the lithium battery. Therefore, this is also a technical issue that needs to be resolved, on how to maintain normal charging and discharging of lithium battery in a cold environment.

### BRIEF SUMMARY OF THE INVENTION

In view of the aforesaid disadvantages now present in the prior art, the present invention provides an ultrasonic separation mechanism for storage batteries, in which at least one sealed interior chamber is provided in a separation workpiece, and ultrasonic vibrating elements are installed in the at least one sealed interior chamber. When the ultrasonic separation mechanism is applied between the positive and negative electrodes, the ultrasonic vibrating elements produce high frequency ultrasonic vibration which directly acts on the separation workpiece, creating an ultrasonic cavitation effect. This facilitates the speed of movement of molecules in a substance, effectively prevents the formation of crystals on the separation workpiece by the electrolyte so that the normal functioning of the separation workpiece will not be affected. Therefore, this effectively maintains the storage performance and charge-and-discharge performance of the storage battery, and also prevents the storage battery from inflation and burning.

To attain this, the present invention adopts the following technical solutions:

An ultrasonic separation mechanism for storage batteries, characterized in that it comprises a separation workpiece and at least one ultrasonic vibrating element. The separation workpiece is provided with at least one interior chamber in which the at least one ultrasonic vibration element is installed and sealed inside. Said at least one ultrasonic vibrating element is installed in the at least one interior chamber, and a power supply wire of the ultrasonic separation mechanism extends through the at least one interior chamber and out of the separation workpiece.

Preferably, the separation workpiece is a plate-shaped separator formed by lamination, adherence and sealing of a left separator plate and a right separator plate. Opposing sides of the left separator plate and the right separator plate are each provided with at least one recessed slot; each pair of corresponding recessed slots on the left separator plate and the right separator plate are joined together wherein openings of the corresponding recessed slots on the left separator plate and the right separator plate face towards each other such that a corresponding interior chamber is defined by a space enclosed by the pair of corresponding recessed slots.

Preferably, the separation workpiece is a plate-shaped separator, and a ring body is defined surrounding four sides of the separator. The ring body is provided with one said at least one interior chamber inside and a plurality of said at least one ultrasonic vibrating element are distributed and installed in the interior chamber around the ring body.

Preferably, each ultrasonic vibrating element is an ultrasonic energy converter of 1 MHz or above, or an ultrasonic vibrating motor with a rotational speed of 10,000 RPM.

The advantages of the present invention are: The at least one sealed interior chamber is provided in the separation workpiece and the ultrasonic vibrating elements are installed in the at least one sealed interior chamber. When the ultrasonic separation mechanism is applied between the positive and negative electrodes, the ultrasonic vibrating elements produce high frequency ultrasonic vibration which directly acts on the separation workpiece, creating an ultrasonic cavitation effect. This facilitates the speed of movement of molecules in a substance, effectively prevents the formation of crystals by the electrolyte on the separation workpiece so that the normal functioning of the separation workpieces will not be affected. Therefore, this effectively maintains the storage performance and charge-and-discharge performance of the storage battery, and also prevents the storage battery from inflation and burning. The ultrasonic vibration in high frequency causes the molecules to move rapidly and helps raise the temperature of the battery and enhances the efficiency of charging and discharging, hence solves the problem of low charge-and-discharge efficiency and inability to function normally under extremely cold environment in winter time. The solution also greatly reduces the structural complexity of the ultrasonic battery so that it may be developed in a lighter and more modularized way. The present invention, with a simple structure, is easy to manufacture, hence is able to be developed in an industrialized way. It may be widely applied to storage batteries such as lead acid batteries and lithium batteries to assemble products such as ultrasonic lead acid batteries and ultrasonic lithium batteries.

### BRIEF DESCRIPTION OF THE DRAWINGS

FIG. 1 shows the cross-sectional view of the present invention applied to lead acid battery.

FIG. 2 shows the exploded cross-sectional view of the first embodiment of the present invention applied between the positive and negative electrode plates.

FIG. 3 shows the sectional structural view of A-A in FIG. 2.

FIG. 4 shows the exploded cross-sectional view of the second embodiment of the present invention applied between the positive and negative electrode plates.

FIG. 5 shows the sectional structural view of B-B in FIG. 4.

FIG. 6 shows the exploded cross-sectional view of the third embodiment of the present invention applied between the positive and negative electrode plates.

FIG. 7 shows the sectional structural view of C-C in FIG. 6.

### DETAILED DESCRIPTION OF THE INVENTION

The embodiments of the present invention will be illustrated by the following examples in which the present invention is applied to a lead acid battery to assemble an ultrasonic lead acid battery:

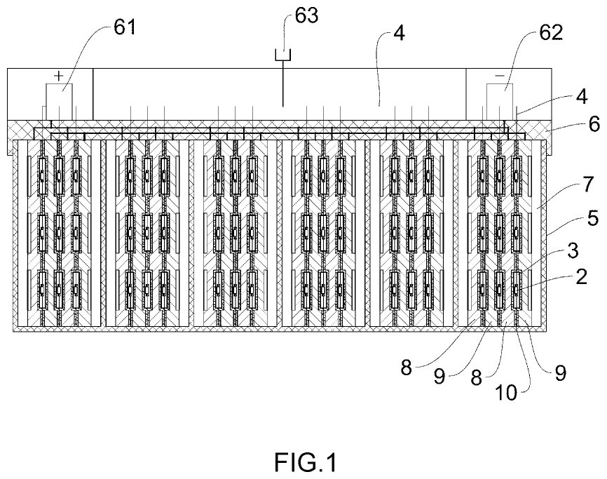

As illustrated in FIG. 1, the ultrasonic lead acid battery comprises a bottom case 5, a cover case 6, a plurality of battery-separating chambers 7 inside the bottom case 5, positive electrode plates 8 and negative electrode plates 9 installed in each of the battery-separating chambers 7, and an ultrasonic separating mechanism 10 clamped between each pair of positive electrode plate 8 and negative electrode plate 9. The amount of positive electrode plates, negative electrode plates and ultrasonic separating mechanisms provided in each of the battery-separating chambers 7 may vary depending on the amount of space of the battery-separating chambers 7. A positive electrode connecting terminal 61 and a negative electrode connecting terminal 62 are provided on the cover case 6. The positive electrode connecting terminal 61 is in parallel connection with all the positive electrode plates 8, while the negative electrode connecting terminal 62 is in parallel connection with all the negative electrode plates 9. Power supply wires 4 of the ultrasonic separating mechanisms 10 are in parallel connection, and provided outside the cover case 6; a pair of connecting terminals 63 is installed for wire connection by users.

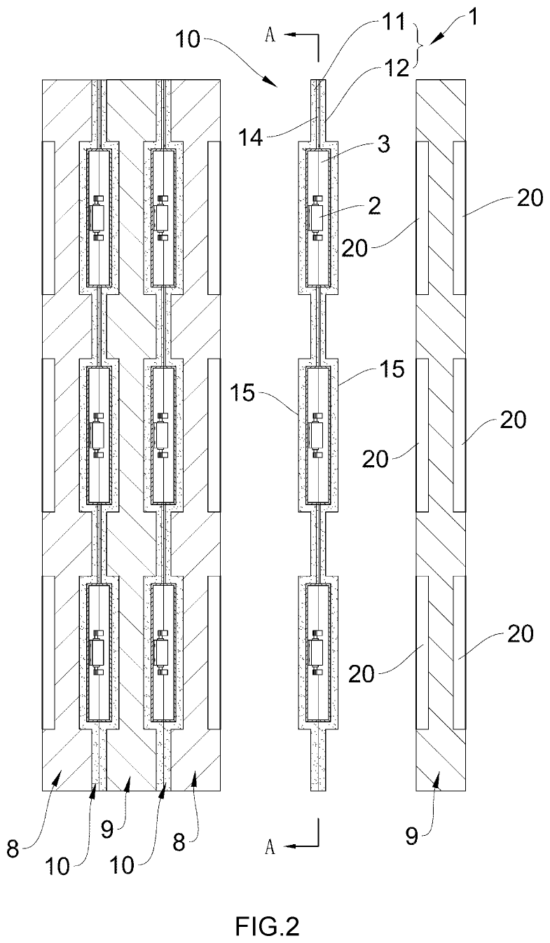

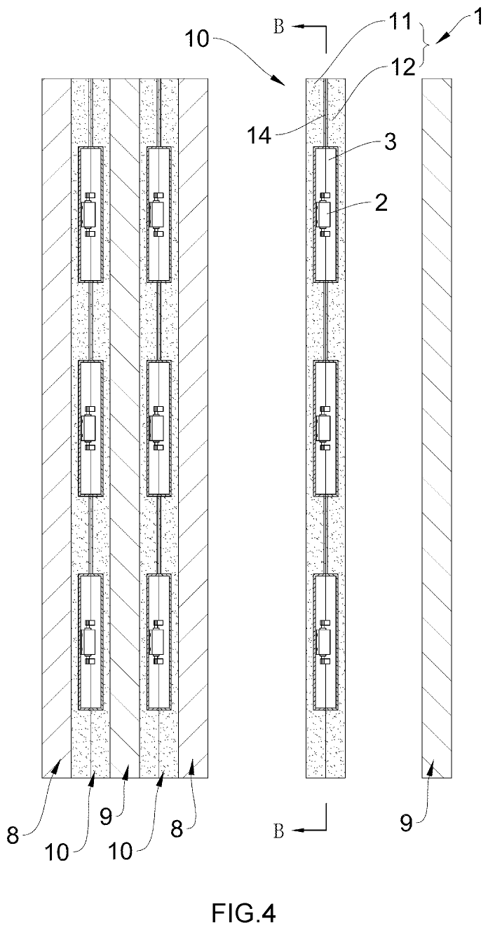

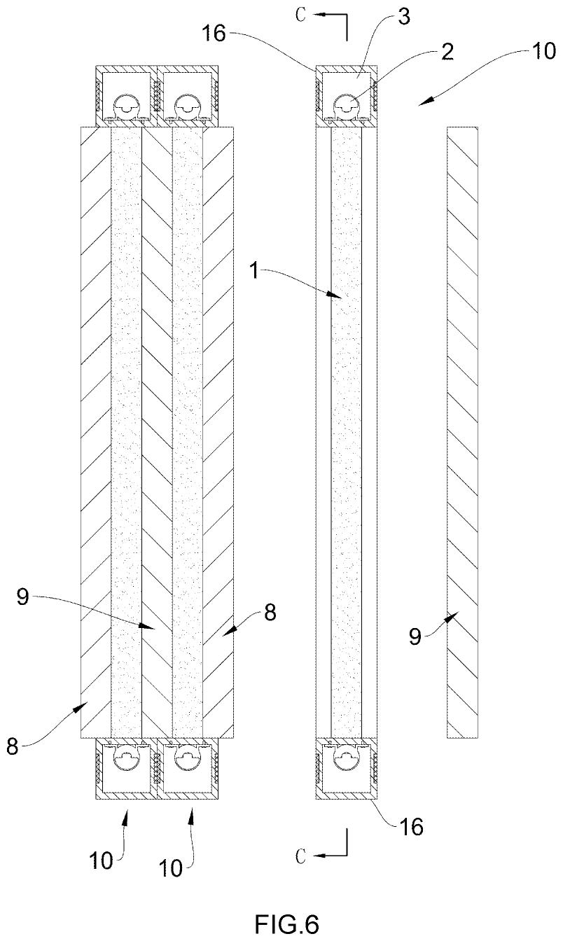

As illustrated in FIG. 2, FIG. 4 or FIG. 6, each ultrasonic separation mechanism comprises a separation workpiece 1 and ultrasonic vibrating elements 2. The separation workpiece 1 is provided with interior chambers 3 for sealed installation of the ultrasonic vibration elements. The ultrasonic vibrating elements 2 are installed in the interior chambers 3 respectively, and the corresponding power supply wire 4 of the ultrasonic separation mechanism extends through the interior chambers 3 and out of the separation workpiece 1, as illustrated in FIG. 1. The shape of the separation workpiece 1 may be designed corresponding to the shape of the battery.

The ultrasonic vibrating elements 2 are installed in the sealed interior chambers 3 to prevent the ultrasonic vibrating elements 2 from being corroded by electrolyte and hence maintaining the usage life of the ultrasonic vibrating elements 2. When the ultrasonic vibrating elements 2 are powered to operate, they create high frequency ultrasonic vibration which directly acts on the separator workpiece 1. The ultrasonic cavitation effect thus created causes the electrolyte to brush the surfaces of the separator workpiece 1, the positive electrode plates 8 and the negative electrode plates 9, and also causes the molecules in the separation workpiece 1 to move more rapidly so as to prevent the formation of crystals on the separation workpiece 1 so that the normal functioning of the separation workpiece will not be affected, hence effectively maintaining the storage performance and charge-and-discharge performance of the storage battery. The ultrasonic vibration in high frequency causes the molecules in a substance to move rapidly, helps raise the temperature of the battery as the molecules in the electrolyte vibrate, and enhances the efficiency of charging and discharging, hence solves the problem of low charge-and-discharge efficiency and inability to function normally under extremely cold environment in winter time.

Base on the above solution of the ultrasonic separation mechanism 10, the present invention may have two different embodiments:

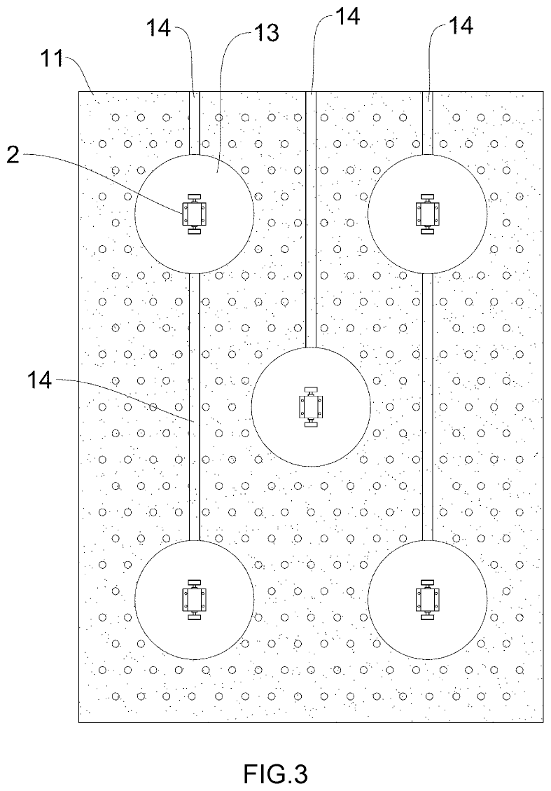

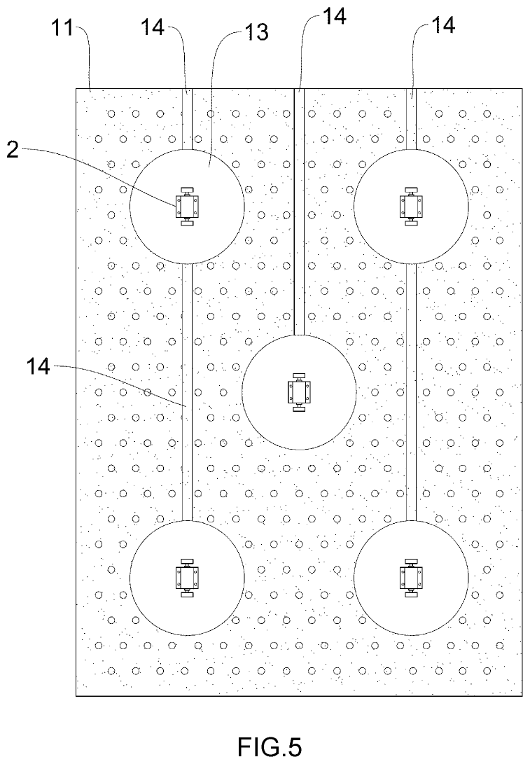

The first embodiment: As illustrated in FIG. 2 and FIG. 3, or in FIG. 4 and FIG. 5, the separation workpiece 1 is a plate-shaped separator, formed by lamination, adherence and sealing of a left separator plate 11 and a right separator plate 12. Opposing sides of the left separator plate 11 and the right separator plate 12 are each provided with recessed slots 13; each pair of corresponding recessed slots 13 on the left separator plate and the right separator plate are joined together with their openings facing towards each other such that a corresponding interior chamber 3 is defined by a space enclosed by the pair of corresponding recessed slots 13. A wire duct 14 is also provided between the opposing sides of the left separator plate 11 and the right separator plate 12 for wiring arrangement of the power supply wire 4. During assembling, fix and install the ultrasonic vibrating elements 2 in the recessed slots 13, arrange the power supply wire 4 along the wire duct 14, and then laminate, adhere and seal the left separator plate 11 and the right separator plate 12 together to assemble the ultrasonic separating mechanism 10.

Depending on how the shapes of the left separator plate 11 and the right separator plate 12 are configured, the present invention may have two different embodiments, one illustrated in FIG. 2 and FIG. 3 and the other one illustrated in FIG. 4 and FIG. 5. As illustrated in FIG. 2 and FIG. 3, raised portions 15 are defined on external sides of the left separation plate 11 and the right separation plate 12 facing away from each other at positions corresponding to the recessed slots 13. This embodiment as illustrated in FIG. 2 and FIG. 3 allows a thinner separation workpiece 1 and a correspondingly smaller battery. When adopting this embodiment as illustrated in FIG. 2 and FIG. 3, the positive electrode plate 8 and the negative electrode plate 9 are designed to have recessed areas 20 correspondingly nested by the raised portions 15, so that the positive electrode plate 8 and the negative electrode plate 9 may be fitted and laminated with the separation workpiece 1. The embodiment illustrated by FIG. 4 and FIG. 5 shows the separation workpiece 1 of a conventional thickness without any optimization.

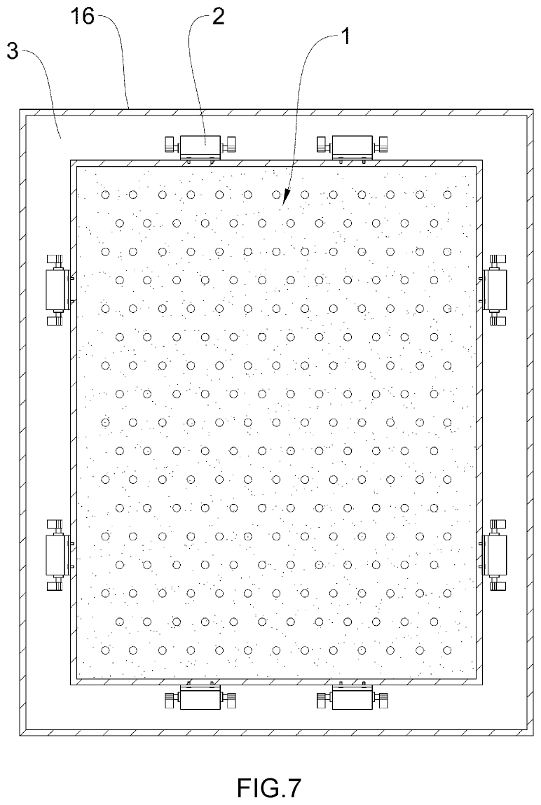

The second embodiment: As illustrated by FIG. 6 and FIG. 7, the separation workpiece 1 plate-shaped separator with a ring body 16 surrounding four sides of the separator. The ring body 16 is defined with only one interior chamber 3 inside, and the ultrasonic vibrating elements 2 are distributed and installed in the interior chamber 3 around the ring body 16. This is an encircling type of embodiment in which a plurality of the ultrasonic vibrating elements 2 is arranged in an encircling pattern for an effective synchronized ultrasonic treatment of the separation workpiece 1.

Each of the ultrasonic vibrating elements 2 is an ultrasonic energy converter of 1 MHz or above, or an ultrasonic vibrating motor with a rotational speed of 10,000 or above, RPM for a better effect of ultrasonic cavitation. The ultrasonic vibrating element may have a flat shape or a bar shape depending on its site in the battery. In actual usage, the present invention generally comprises a controller or a host to control all ultrasonic vibrating elements in the battery. The controller or the host is provided with a main control circuit board in which a programmable MCU (main control unit) main control chip, and a WIFI communication module or a Bluetooth® communication module may be added. Wireless communication and control will be achieved via a corresponding programmed APP installed in smart phones or tablets. Wire control or remote control may also be used to operate the present invention.

What is claimed is:

1. An ultrasonic separation mechanism for storage batteries, comprising a separation workpiece (1) and at least one ultrasonic vibrating element (2); the separation workpiece (1) is provided with at least one interior chamber (3) in which the at least one ultrasonic vibration element (2) is installed and sealed inside; said at least one ultrasonic vibrating element (2) is installed in the at least one interior chamber (3), and a power supply wire (4) of the ultrasonic separation mechanism extends through the at least one interior chamber (3) and out of the separation workpiece (1).

2. The ultrasonic separation mechanism for storage batteries as in claim 1, wherein the separation workpiece (1) is a plate-shaped separator formed by lamination, adherence and sealing of a left separator plate (11) and a right separator plate (12); opposing sides of the left separator plate (11) and the right separator plate (12) are each provided with at least one recessed slot (13); each pair of corresponding recessed slots (13) on the left separator plate (11) and the right separator plate (12) are joined together wherein openings of the corresponding recessed slots (13) on the left separator plate (11) and the right separator plate (12) face towards each other such that a corresponding interior chamber (3) is defined by a space enclosed by the pair of corresponding recessed slots (13).

3. The ultrasonic separation mechanism for storage batteries as in claim 2, wherein a wire duct (14) is also provided between the opposing sides of the left separator plate (11) and the right separator plate (12); the power supply wire (4) passes through the wire duct (14).

4. The ultrasonic separation mechanism for storage batteries as in claim 2, wherein raised portions (15) are defined on external sides of the left separation plate (11) and the right separation plate (12) facing away from each other at positions corresponding to the recessed slots (13).

5. The ultrasonic separation mechanism for storage batteries as in claim 1, wherein the separation workpiece (1) is a plate-shaped separator, and a ring body (16) is provided surrounding four sides of the separator; the ring body (16) is defined with one said at least one interior chamber (3) inside and a plurality of said at least one ultrasonic vibrating element (2) are distributed and installed in the interior chamber (3) around the ring body (16).

6. The ultrasonic separation mechanism for storage batteries as in claim 5, wherein each ultrasonic vibrating element is an ultrasonic energy converter of 1 MHz or above, or an ultrasonic vibrating motor with a rotational speed of 10,000 RPM.
